(19) United States
(12) Patent Application Publication
(10) Pub. No.: US 2008/0012177 A1
(43) Pub. Date: Jan. 17, 2008

(54) Mold unit and method for forming centrifugal fan, and fan-forming apparatus having mold unit

(75) Inventors: Shuichi Tamaki, Nishio-city (JP); Hisashi Sawada, Okazaki-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/827,410

(22) Filed: Jul. 11, 2007

(30) Foreign Application Priority Data
Jul. 13, 2006 (JP) 2006-193250

(51) Int. Cl. B29C 33/38

(52) U.S. Cl. 264/310; 425/457

(57) ABSTRACT

A mold unit for molding a centrifugal fan that has blades arranged in a circumferential direction, each blade extending in a direction that is inclined in a circumferential direction at a predetermined angle relative to a direction parallel to a rotation axis, has a fixed mold and a movable mold. The fixed mold and the movable mold provides a cavity for molding the fan therebetween. At least one of the fixed mold and the movable mold has a blade-molding core member for molding the blades. When separating the blade-molding core member from the blades, the blade-molding core member is moved in a spiral manner along inclination of the blades and about the rotation axis.

### CROSS REFERENCE TO RELATED APPLICATION

This application is based on Japanese Patent Application No. 2006-193250 filed on Jul. 13, 2006, the disclosure of which is incorporated herein by reference.

### FIELD OF THE INVENTION

The present invention relates to a mold unit and a method for forming a centrifugal fan and a fan-forming apparatus having the mold unit.

### BACKGROUND OF THE INVENTION

A mold unit for forming a sirocco fan as a centrifugal fan is for example disclosed in Unexamined Japanese Patent Publication No. 2004-34548. The sirocco fan has blades arranged in a circumferential direction about a rotation axis. In the mold unit, the blades are molded in radial outer portions of a cavity that is provided between a fixed ring engaged in a body of a fixed mold and a movable ring engaged with a body of a movable mold.

The radial outer portions of the cavity for forming the blades extend in a direction parallel to a mold opening direction in which the fixed mold and the movable mold are open. The blades molded in the radial outer portions of the cavity extend in a direction parallel to the rotation axis.

In order to increase performance and reduce fan noise, a centrifugal fan having blades that extend in directions inclined in the circumferential direction at predetermined angles relative to the rotation axis has been required. In this centrifugal fan, the blades form undercut structures in a mold opening direction. In general, if a molded product forms undercut structure, it is likely to be difficult to eject the product from molds.

### SUMMARY OF THE INVENTION

The present invention is made in view of the foregoing matter, and it is an object of the present invention to provide a mold unit for forming a centrifugal fan having blades that are inclined in a circumferential direction at a predetermined angle relative to a rotation axis, which is capable of easing ejection of a molded centrifugal fan from the mold unit, and a method and an apparatus for forming the centrifugal fan using the mold unit.

According to an aspect of a mold unit, a first mold and a second mold provides a cavity therebetween when disposed in a mold close position. The cavity has a shape corresponding to the centrifugal fan for molding the centrifugal fan therein. At least one of the first mold and the second mold is movable in a mold opening direction, which is parallel to the rotation axis of the centrifugal fan to be molded in the cavity, to open the cavity. Further, at least one of the first mold and the second mold has a blade-molding core member and a spiral movement generating structure. The blade-molding core member defines at least a portion of the cavity for molding the blades of the centrifugal fan. The spiral movement generating structure is configured to move the blade-molding core member in a spiral manner along inclination of the blades about the rotation axis.

Accordingly, the blade-molding core member is moved in the spiral manner along the inclination of the blades and about the rotation axis by the spiral movement generating structure. Therefore, even when the blades, which are inclined in the circumferential direction, form undercut structure in the mold opening direction, the centrifugal fan is easily ejected from the mold unit.

According to an aspect of a method for forming the centrifugal fan, a molten resin is injected into a cavity provided between a first mold and a second mold, and the first mold and the second mold are opened after the resin is solidified. The centrifugal fan molded in the cavity is ejected from the second mold. Further, a blade-molding core member, which is included in at least one of the first mold and the second mold and defines at least a portion of the cavity for molding the blades, is moved in a spiral manner along inclination of the blades and about the rotation axis for separating the blade-molding core member from the blades, before the centrifugal fan is ejected from the second mold.

Accordingly, since the blade-molding core member is moved in the spiral manner before the ejecting, it is easily separated from the blades, which for the undercut structure in the mold opening direction.

According to an aspect of an apparatus for forming the centrifugal fan, a mold unit has a first mold and a second mold providing a cavity therebetween for molding the centrifugal fan therein. At least one of the first mold and the second mold is movable in a mold opening direction, which is parallel to the rotation axis of the centrifugal fan to be molded in the cavity, to open the mold unit. At least one of the first mold and the second mold has a blade-molding core member and a spiral movement generating structure. The blade-molding core member defines at least a portion of the cavity for molding the blades of the centrifugal fan, and the spiral movement generating structure is configured to move the blade-molding core member in a spiral manner along inclination of the blades about the rotation axis. The mold unit is opened and closed by a mold opening and closing unit. The centrifugal fan molded in the cavity is ejected from the second mold by an operation of an ejecting unit. Also, the spiral movement generating structure is driven by a driving device. The mold opening and closing unit, the ejecting unit and the driving device are controlled by a control unit.

Accordingly, the centrifugal fan having the blades inclined in the circumferential direction is easily formed by the apparatus. The blades, which form the undercut structure, are easily separated from the blade-forming core member.

### BRIEF DESCRIPTION OF THE DRAWINGS

Other objects, features and advantages of the present invention will become more apparent from the following detailed description made with reference to the accompanying drawings, in which like parts are designated by like reference numbers and in which:

FIG. 1 is a schematic cross-sectional view of a mold unit for forming a centrifugal fan according to an embodiment of the present invention;

FIG. 2 is a perspective view of the mold unit according to the embodiment;

FIG. 3A is a cross-sectional view of an engagement structure between a blade-molding core member of a fixed mold of the mold unit and a main body of the fixed mold, taken along a line IIIA-IIIA in FIG. 2;

FIG. 3B is a cross-sectional view of the engagement structure, taken along a line IIIB-IIIB in FIG. 2;

FIG. 4 is a cross-sectional view of an engagement structure between a supporting block and a wedge plate of the fixed mold according to the embodiment;

FIG. 5 is a schematic block diagram of a fan-forming apparatus including the mold unit for forming the centrifugal fan according to the embodiment;

FIG. 6A is an axial end view of the centrifugal fan according to the embodiment;

FIG. 6B is a side view of the centrifugal fan according to the embodiment;

FIG. 7 is a perspective view of the centrifugal fan according to the embodiment;

FIG. 8 is a schematic cross-sectional view of the mold unit in a mold-closing step of a process for molding the centrifugal fan according to the embodiment;

FIG. 9 is a schematic cross-sectional view of the mold unit in a filling step and a cooling step of the molding process according to the embodiment;

FIG. 10 is a schematic cross-sectional view of the mold unit in a mold-opening step of the molding process according to the embodiment;

FIG. 11 is a schematic cross-sectional view of the mold unit in an ejecting step of the molding process according to the embodiment;

FIG. 12A is a cross-sectional view of the mold unit in the filling step and the cooling step, taken along a line XIIA-XIIA in FIG. 2;

FIG. 12B is a cross-sectional view of the mold unit in the filling step and the cooling step, taken along a line XIIB-XIIB in FIG. 2;

FIG. 13A is a cross-sectional view of the mold unit in a spirally moving step of the fixed mold of the molding process, taken at a position corresponding to the line XIIA-XIIA in FIG. 2;

FIG. 13B is a cross-sectional view of the mold unit in the spirally moving step of the fixed mold, taken at a position corresponding to the line XIIB-XIIB in FIG. 2;

FIG. 14 is an explanatory sectional view, taken at a position corresponding to a line XIV-XIV in FIG. 6, in the spirally moving step of the fixed mold;

FIG. 15A is a cross-sectional view of the mold unit in the mold-opening step, taken at a position corresponding to the line XIIA-XIIA in FIG. 2;

FIG. 15B is a cross-sectional view of the mold unit in the mold-opening step, taken at a position corresponding to the line XIIB-XIIB in FIG. 2;

FIG. 16A is a cross-sectional view of the mold unit in a spirally moving step of the movable mold of the molding process, taken at a position corresponding to the line XIIA-XIIA in FIG. 2;

FIG. 16B is a cross-sectional view of the mold unit in the spirally moving step of the movable mold, taken at a position corresponding to the line XIIB-XIIB in FIG. 2;

FIG. 17 is an explanatory sectional view, taken at a position corresponding to a line XVII-XVII in FIG. 6, in the spirally moving step of the movable mold;

FIG. 18A is a cross-sectional view of the mold unit in the ejecting step, taken at a position corresponding to the line XIIA-XIIA in FIG. 2;

FIG. 18B is a cross-sectional view of the mold unit in the ejecting step, taken at a position corresponding to the line XIIB-XIIB in FIG. 2; and

FIG. 19 is a time chart from the spirally moving step of the fixed mold to the ejecting step performed by the fan-forming apparatus according to the embodiment.

### DETAILED DESCRIPTION OF EXAMPLE EMBODIMENT

An embodiment of the present invention will now be described with reference to the drawings.

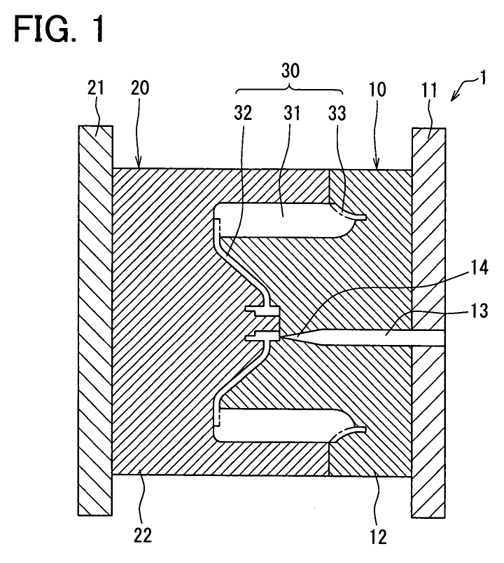

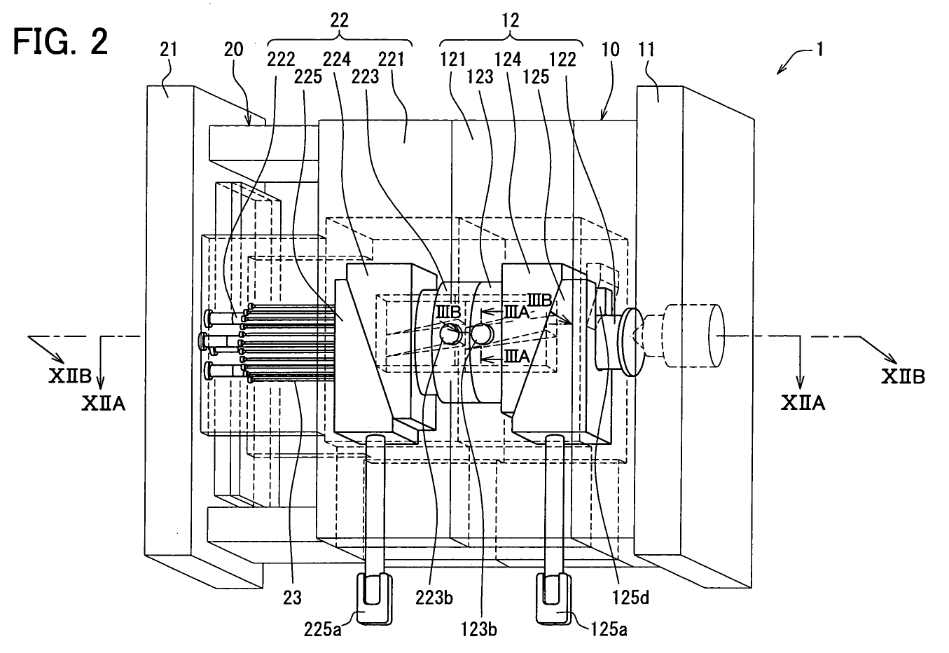

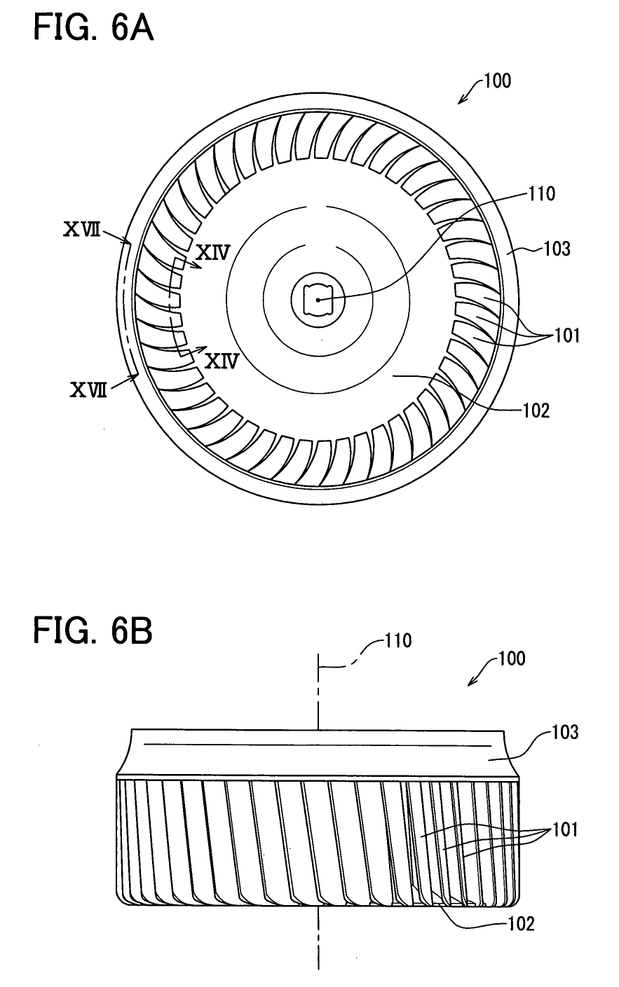

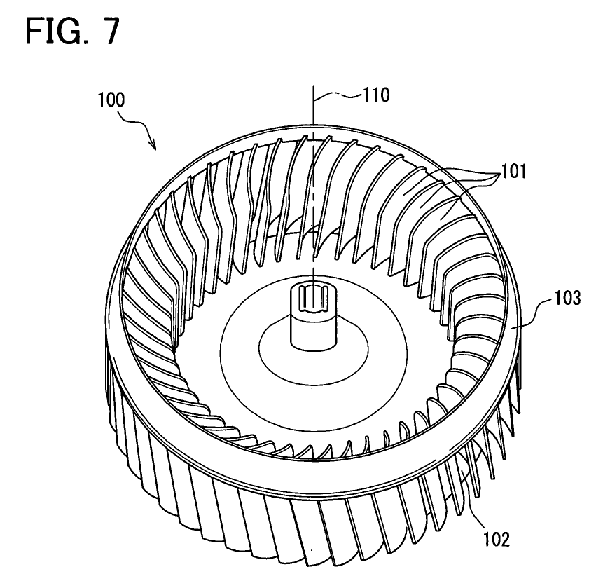

Referring to FIGS. 1 and 2, a mold unit 1 is used for molding a sirocco fan 100 as a centrifugal fan shown in FIGS. 6A, 6B and 7. The mold unit 1 is included in a fan-forming apparatus shown in FIG. 5.

Referring to FIGS. 6A, 6B, and 7, the fan 100 is for example formed of a resin such as polypropylene or polyamide. The fan 100 includes blades 101, a disc portion 102 and a shroud ring portion 103. The blades 101 are arranged in a circumferential direction about a rotation axis 110. The disc portion 102 has a substantially disc shape formed with an opening at its center for receiving a rotation shaft. The disc portion 102 connects to ends (e.g., bottom ends in FIGS. 6B and 7) of the blades 101. The shroud ring portion 103 has a substantially ring shape and connects to ends (e.g., upper ends in FIGS. 6B and 7) of the blades 101 on a side opposite to the disc portion 102.

Namely, the blades 101 extends between the disc portion 102 and the shroud ring portion 103. Further, each of the blades 101 is inclined in the circumferential direction at a predetermined angle relative to a direction parallel to the rotation axis 110, as shown in FIG. 6B.

As shown in FIG. 1, the mold unit 1 generally includes a fixed mold 10 and a movable mold 20 (e.g., first mold, second mold). The fixed mold 10 has a fixed board 11 and a mold section 12 fixed to the fixed board 11. The fixed board 11 is fixed to a fixed platen of an injection molding device (not shown). The movable mold 20 has a movable board 21 and a mold section 22 fixed to the movable board 21. The movable board 21 is fixed to a movable platen (not shown) that is movable back and forth relative to the fixed platen.

The fixed mold 10 and the movable mold 20 are closed such that the molds sections 12, 22 thereof are opposed to each other. The mold sections 12, 22 have predetermined shapes, and thus, when the fixed mold 10 and the movable mold 20 are closed, a cavity for molding the fan 100 is provided between the mold sections 12, 22. The cavity 30 is also referred to as a product portion 30 in which the fan 100 is formed.

The fixed mold 10 and the movable mold 20 are opened and closed in a direction parallel to the rotation axis 110 of the fan 100. Hereafter, the direction is also referred to as a mold opening/closing direction. The mold opening/closing direction corresponds to a right and left direction in FIG. 1.

The product portion 30 includes blade-molding portions 31 for molding the blades 101, a disc-molding portion 32 for molding the disc portion 102 and a ring-molding portion 33 for molding the shroud ring portion 103.

The fixed mold 10 is formed with a sprue 13 as a passage for supplying a molten resin into the product portion 30. Also, the fixed mold 10 is formed with a gate 14 at a downstream end of the sprue 13 as an injection opening for injecting the molten resin into the product portion 30. The gate 14 is located adjacent to a center of the disc-molding portion 32, i.e., at a position corresponding to a peripheral portion of the opening of the disc portion 102.

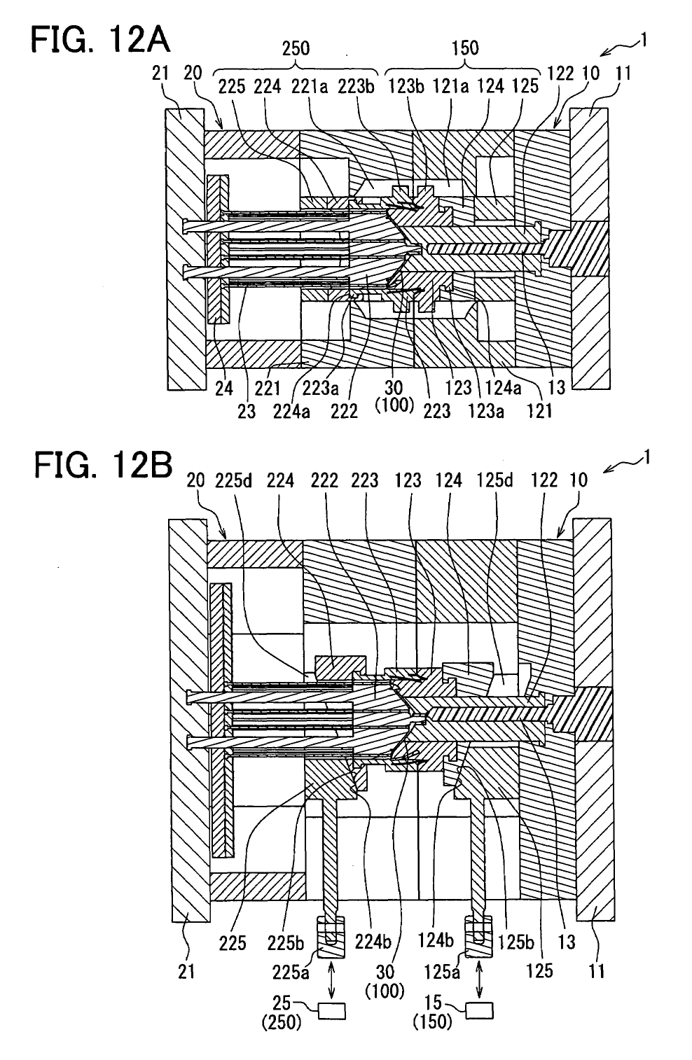

As shown in FIGS. 2, 12A and 12B, the mold section 12 of the fixed mold 10 has a main body 121, a passage-forming member 122, a blade-molding core member 123 for molding the blades 101, a supporting block 124 and a wedge plate 125. The passage-forming member 122, the blade-molding core member 123, the supporting block 124 and the wedge plate 125 are located inside of the main body 121.

The passage-forming member 122 is a generally columnar member defining an opening therein as the sprue 13. An end of the passage-forming member 122 (e.g., left end in FIG. 12A), which is on a side opposite to the fixed board 11, has a surface that partly defines the disc-molding portion 32.

The blade-molding core member 123 is a generally cylindrical member and is disposed on a radially outside of the passage-forming member 122. Also, the blade-molding core member 123 is disposed slidable along a radially outer surface of the passage-forming member 122. As shown in FIG. 12A, the blade-molding core member 123 has an end surface that defines a radially outer portion of the disc-molding portion 32, a surface that partly defines a right side of the ring-molding portion 33, and surfaces that partly define the blade-molding portions 31 on the right side of the disc-molding portion 32.

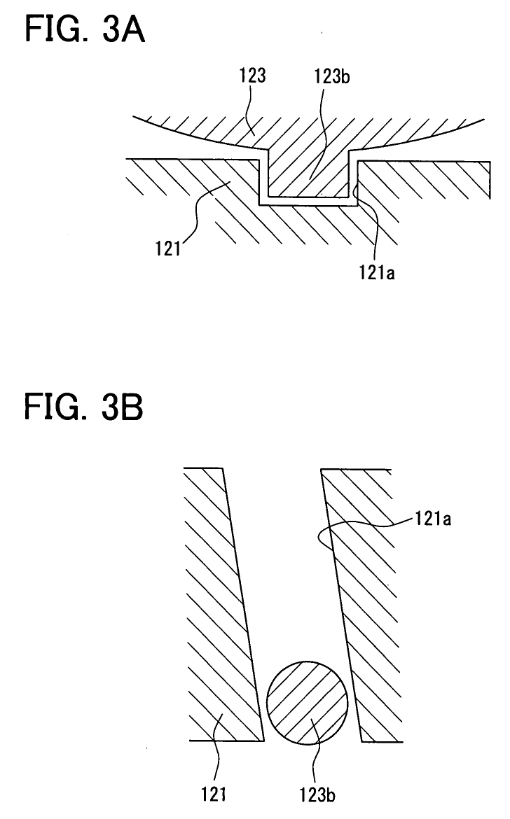

Further, the blade-molding core member 123 has an annular projection portion 123a having an annular projection projecting in a radially outward direction in a form of flange at an end (right end in FIG. 12A) thereof. The blade-molding core member 123 also has a pair of guide pins 123b that projects in the radially outward direction. As shown in FIGS. 2, 3A and 3B, each of the guide pins 123b for example has a columnar shape and is configured to be received in a guide groove 121 a formed on an inner surface of the main body 121.

The guide groove 121a extends in a direction that is inclined at a predetermined angle relative to the mold opening/closing direction (right and left direction in FIG. 2). The predetermined angle of inclination of the guide groove 121a is equal to the predetermined angle of inclination of the blades 101, i.e., the blade-molding portions 31. In other words, the guide groove 121a is inclined along the inclination of the blades 101. The guide groove 121a and the guide pin 123b provide a guiding part.

The structure of the guiding part may not be limited to the above. Also, the shape of the guide pin 123 is not limited to the columnar shape. For example, the guide pin may be formed on the main body 121, and the guide groove may be formed on the blade-molding core member 123.

As shown in FIGS. 12A and 12B, the supporting block 124 as a supporting member is disposed on a right side of the blade-molding core member 123. The supporting block 124 is a generally cylindrical member and is disposed to be slidable along the radially outer surface of the passage-forming member 122. The supporting block 124 is formed with an annular groove portion 124a defining an annular groove at an end (left end in FIG. 12A) thereof.

The annular groove portion 124a engages with the annular projection portion 123a of the blade-molding core member 123. Thus, the supporting block 124 supports the blade-molding core member 123 such that the blade-molding core member 123 is rotatable about the rotation axis 110.

The wedge plate 125 as a sliding member is disposed on a right side of the supporting block 124, as shown in FIGS. 12A and 12B. The wedge plate 125 has a wedge plate portion and an extension portion extending from the wedge plate portion (e.g., in a downward direction in FIG. 12B). The extension portion has a connection end 125a at an end thereof to be connected to an output end of a hydraulic cylinder 15 (driving device) of the fan-forming apparatus shown in FIG. 5.

The wedge plate portion of the wedge plate 125 has a wedge shape such that a thickness reduces toward an end opposite to the extension portion (e.g., in an upward direction in FIG. 12B). The wedge plate portion has an inclined surface 125b at an end that faces the supporting block 124. The inclined surface 125b is inclined relative to a plane that is perpendicular to the mold opening/closing direction. As shown in FIG. 12B, the supporting block 124 has an inclined surface 124b on an end that faces the wedge plate 125. The inclined surface 124b of the supporting block 124 extends along the inclined surface 125b of the wedge plate 125.

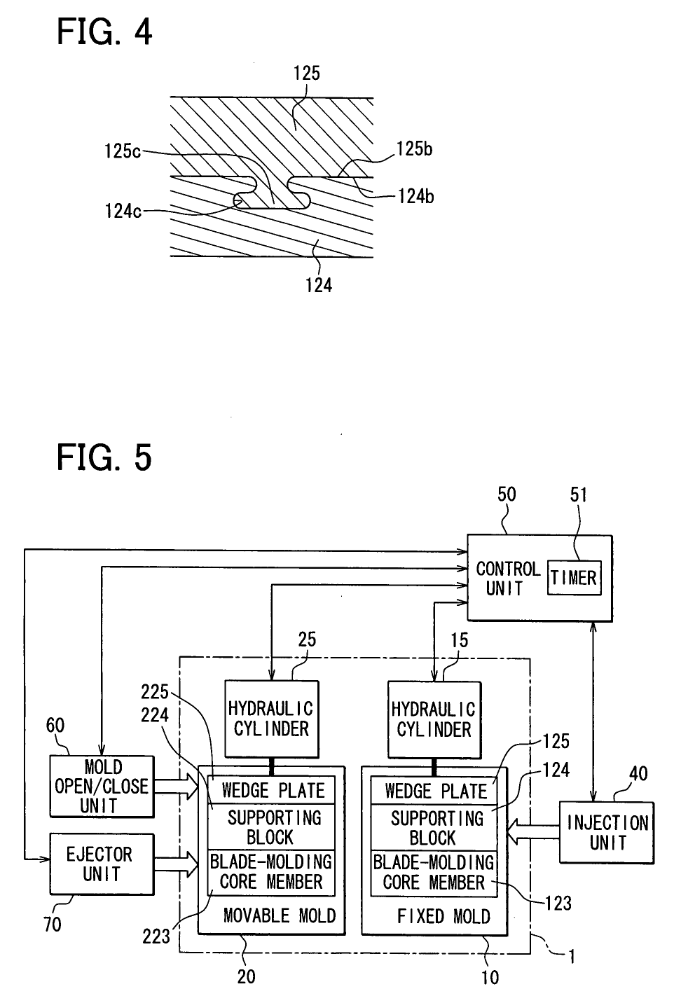

Although not illustrated in FIGS. 2, 12A, 12B, the wedge plate 125 has an engagement projection 125c on the inclined surface 125b, as shown in FIG. 4. The engagement projection 125c extends in an up and down direction in FIG. 2. Also, the supporting block 124 has an engagement groove 124c on the inclined surface 124b. The engagement groove 124c has a shape corresponding to the engagement projection 125c and engages with the engagement projection 125c.

The engagement structure between the wedge plate 125 and the supporting block 124 is not limited to the engagement projection 125c and the engagement groove 124c shown in FIG. 4. For example, the engagement groove may be formed on the inclined surface 125b of the wedge plate 125, and the engagement projection 124b may be formed on the inclined surface 124b of the supporting block 124.

By the engagement structure of the engagement projection 125c and the engagement groove 124c, when the wedge plate 125 is moved in a direction perpendicular to the mold opening/closing direction, the supporting block 124 is moved in a direction parallel to the mold opening/closing direction. Namely, when the wedge plate 125 slides in the downward direction in FIGS. 2 and 12B, a biasing force for biasing the blade-molding core member 123 in the mold opening direction is applied to the blade-molding core member 123 through the supporting block 124.

When the blade-molding core member 123 receives the biasing force, the blade-molding core member 123 moves in the mold opening direction while rotating along the inclination of the guide grooves 121a and about the rotation axis 110 since the guide pins 123b of the blade-molding core member 123 are guided in the guide grooves 121a which are inclined at the predetermined angle relative to the rotation axis 110. In other words, the blade-molding core member 123 is moved in a spiral manner along the inclination of the blades 101 and about the rotation axis 110 due to the biasing force and the guiding part of the guide grooves 121a and the guide pins 123b.

Here, the supporting block 124, the wedge plate 125 and the hydraulic cylinder 15 provide a biasing-force generating part of the fixed mold 10. Further, the biasing-force generating part and the guiding part, which includes the guide groove 121a and the guide pin 123b, provide a spiral movement generating structure 150 as a spirally moving means.

As shown in FIGS. 2, 12A, 12B, the wedge plate 125 is formed with a notched portion 125d at a position corresponding to the passage-forming member 122 so as to restrict interference with the passage-forming member 122 during the sliding operation. The notched portion 125d has a substantially U-shape, for example. However, the shape of the notched portion 125d is not limited to the substantially U-shape, but may be an oval or another shape as long as the interference with the passage-forming member 122 is restricted.

As shown in FIG. 2, the mold section 22 of the movable mold 20 has a main body 221, a guide core member 222, a blade-molding core member 223, a supporting block 224 and a wedge plate 225. The guide core member 22, the blade-molding core member 223, the supporting block 224 and the wedge plate 225 are located inside of the main body 221.

As shown in FIGS. 12A and 12B, an end (e.g., left end) of the guide core member 222 is embedded in the movable board 21, and ejector pins 23 are provided on peripheries of the guide core member 222. The ejector pins 23 are configured to be pushed into the product portion 30 by an ejector plate 24. The guide core member 222 guides the ejector pins 23 when the ejector pins 23 are pushed by the ejector plate 24.

An opposite end (e.g., right end in FIG. 12A) of the guide core member 222 has a predetermined shape to define one side (right side in FIG. 12A) of the disc-molding portion 32 of the product portion 30.

The blade-molding core member 223 is a generally cylindrical member and is disposed slidable along a radially outer surface of the guide core member 222. The blade-molding core member 223 has a surface that defines one side (left side in FIG. 12A) of the ring-forming member 33, and surfaces that define the blade-molding portions 31 on the left side of the disc-molding portion 32.

The blade-molding core member 223 has an annular projection portion 223a at an end (e.g., left end in FIG. 12A) thereof. The annular projection portion 223a has an annular projection that projects in a radially outward direction in a form of flange. Also, the blade-molding core member 223 has a pair of guide pins 223b that project in the radially outward direction from a radially outer surface thereof. Each of the guide pins 223b has a columnar shape, for example.

The main body 221 of the movable mold 20 has guide grooves 221a on its inner surface. The guide pins 223b are configured to be received in the guide grooves 221a. The engagement structure of the guide pins 223b and the guide grooves 221a is similar to the engagement structure of the guide pins 123b and the guide grooves 121a of the fixed mold 10 shown in FIGS. 3A and 3B.

The guide grooves 221a extend in a direction inclined at a predetermined angle relative to the mold opening/closing direction (left and right direction in FIG. 2). The predetermined angle is equal to the angle of inclination of the blade-molding portions 31, i.e., the blades 101. The guide grooves 221a and the guide pins 223b provide a guiding part of the movable mold 20.

The engagement structure of the guide pins 123b and the guide grooves 121a is not limited to the above. Also, the shape of the guide pins 123b is not limited to the columnar shape. For example, the guide pins may be formed on the main body 221, and the guide grooves may be formed on the blade-molding core member 223.

The supporting block 224 as a supporting member is located on a left side of the blade-molding core member 223 as shown in FIGS. 2, 12A and 12B. The supporting block 224 is a generally cylindrical member. The supporting block 224 has an annular groove portion 224a defining an annular groove at an end adjacent to the blade-molding core member 223. The annular groove portion 224a engages with the annular projection portion 223a of the blade-molding core member 223.

The supporting block 224 supports the blade-molding core member 223 through the engagement of the annular projection portion 223a and the annular groove portion 224a such that the blade-molding core member 223 is rotatable about the rotation axis 110.

The wedge plate 225 as a sliding member is disposed on a side opposite to the blade-molding core member 223 with respect to the supporting block 224. The wedge plate 225 includes a wedge plate portion and an extension portion extending from the wedge plate portion, e.g., in the downward direction in FIG. 12B. The extension portion has an end to be connected to an output end of a hydraulic cylinder 25 (driving device) of the fan-forming apparatus shown in FIG. 5.

The wedge plate portion has a wedge shape in which a thickness reduces in a direction opposite to the extension portion (e.g., in the upward direction in FIG. 12B). The wedge plate portion has an inclined surface 225b that is inclined relative to a plane extending perpendicular to the mold opening direction. The supporting block 224 has an inclined surface 224b on a side facing the wedge plate 225. The inclined surface 224b extends along the inclined surface 225b of the wedge plate 225.

The inclined surfaces 224b, 225b have an engagement groove and an engagement projection engaging with the engagement groove, respectively, similar to the inclined surfaces 124b, 125b of the fixed mold 10 shown in FIG. 4. Here, the engagement structure of the inclined surfaces 224b, 225b is not limited to the structure shown in FIG. 4. For example, the engagement groove may be formed on the inclined surface 225b of the wedge plate 225, and the engagement projection may be formed on the inclined surface 224b of the supporting block 224.

The wedge plate 225 is movable in the direction perpendicular to the mold opening/closing direction by the driving device, similar to the wedge plate 125 of the fixed mold 10. When the wedge plate 225 is moved in the direction perpendicular to the mold opening/closing direction by the driving device, the supporting block 224 is moved in the direction parallel to the mold opening/closing direction due to the engagement structure of the engagement groove and the engagement projection.

Namely, when the wedge plate slides in the downward direction in FIGS. 2 and 12B, a biasing force for biasing the blade-molding core member 223 in the direction parallel to the mold opening direction is applied to the blade-molding core member 123 through the supporting block 224. At this time, since the guide pins 223b of the blade-molding core member 223 are guided in the guide grooves 221a, the blade-molding core member 223 is moved while rotating along the inclination of the guide groove 221a and about the rotation axis 110. In other words, the blade-molding core member 223 is moved in a spiral manner along the inclination of the blades 101 and about the rotation axis 110 due to the biasing force and the guiding part provided by the guide grooves 221a and the guide pins 223b.

Here, the supporting block 224, the wedge plate 225 and the hydraulic cylinder 25 provide a biasing-force generating part of the movable mold 20. The biasing-force generating part and the guiding part, which includes the guide grooves 221a and the guide pins 223b, provide a spiral movement generating structure 250 as a spirally moving means. Further, the ejector pins 23, the ejector plate 24 and the guide core member 222 provide an ejector device.

The wedge plate portion of the wedge plate 225 has a notched portion 225d at a position corresponding to the guide core member 222 and the ejector pins 223 so as to restrict interference with the guide core member 222 and the ejector pins 223 during the sliding operation. The notched portion 225d has a substantially U-shape, for example. However, the shape of the notched portion 225d is not limited to the substantially U-shape as long as the interference with the guide core member 222 and the ejector pins 223 is restricted. For example, the notched portion 225d may has an oval shape or the like.

As shown in FIG. 5, the fan forming apparatus includes a mold opening and closing unit 60, an ejector unit 70, an injection unit (injecting and filling device) 40 and a control unit 50, in addition to the mold unit 1 described in the above. The hydraulic cylinders 15, 25 are included in the mold unit 1. The mold opening and closing unit 60 is provided to open and close the mold unit 1 by operating the movable mold 20. The ejector unit 70 is provided to remove the product from the product portion 30 by operating the ejector device of the movable mold 20. The injection unit-40 is provided to inject the molten resin into the mold unit 1, as well-known.

Also, the control unit 50 as a control means is provided to control operations of the injection unit 40, the mold opening and closing unit 60 on which the mold unit 1 is mounted, and the ejector unit 70.

The control unit 50 outputs signals to the injection unit 40, the mold opening and closing unit 60, and the ejector unit 70 such that a molding cycle is performed. That is, based on the signals from the control unit 50, the mold unit 1 is closed, the injection unit 40 injects the molten resin into the product portion 30 of the closed mold unit 1, the mold unit 1 is opened after cooling and hardening the resin in the product portion 30, and the molded product 100 is ejected from the mold unit 1. Further, the control unit 50 receives signals outputted from the preceding units, the signals indicative of completion of the respective operations, various data and the like.

Also, the control unit 50 outputs operation signals to the hydraulic cylinders 15, 25 and receives signals indicative of operation conditions of the hydraulic cylinders 15, 25.

The control unit 50 includes a memory element. The memory element memorizes information regarding the fan 100 such as molding conditions inputted from an input device as an inputting means (not shown). Also, the memory element grasps the progress of the molding cycle based on the signals from the injection unit 40, the mold opening and closing unit 60, the ejector unit 70 and the hydraulic cylinders 15, 25.

The control unit 50 further includes a timer 51 as a time-counting means. The timer 51 is provided to timely outputs the operation signals to the injection device 40, the mold opening and closing unit 60 and the like.

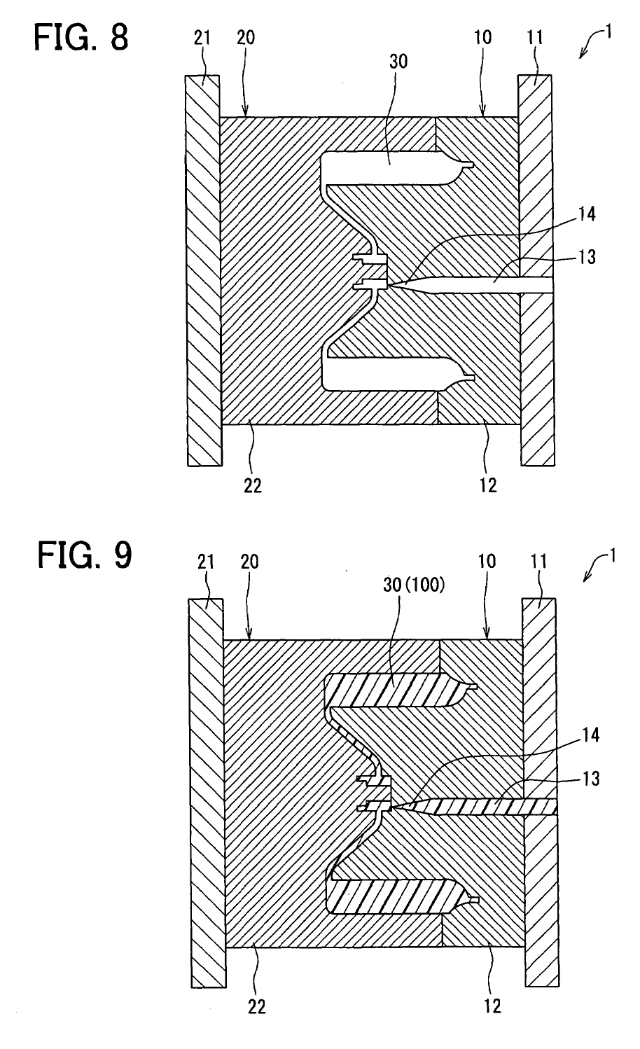

Next, a method of manufacturing the fan 100 using the above-described fan-forming apparatus will be described with reference to FIGS. 8 to 11. FIGS. 8 to 11 show respective steps of a process of molding the fan 100.

First, as shown in FIG. 8, the mold unit 1 is closed by joining the fixed mold 10 and the movable mold 20. Thus, the product portion 30 is provided between the fixed mold 10 and the movable mold 20.

Next, as shown in FIG. 9, a nozzle (not shown) of the injection unit 40 is attached to an upstream end of the sprue 13, and the liquid-phase molten resin is injected into the sprue 13. Thus, the molten resin flows into the product portion 30 through the sprue 13 and the gate 14.

At this time, a temperature of inner surfaces of the mold unit 1 is set to a predetermined temperature that is determined based on resin flow characteristics and mold shrinkage characteristics with crystallization of the resin. Therefore, the molten resin can be filled in the product portion 30 while maintaining low viscosity with relatively high temperature. Also, the crystallization of the resin is progressed.

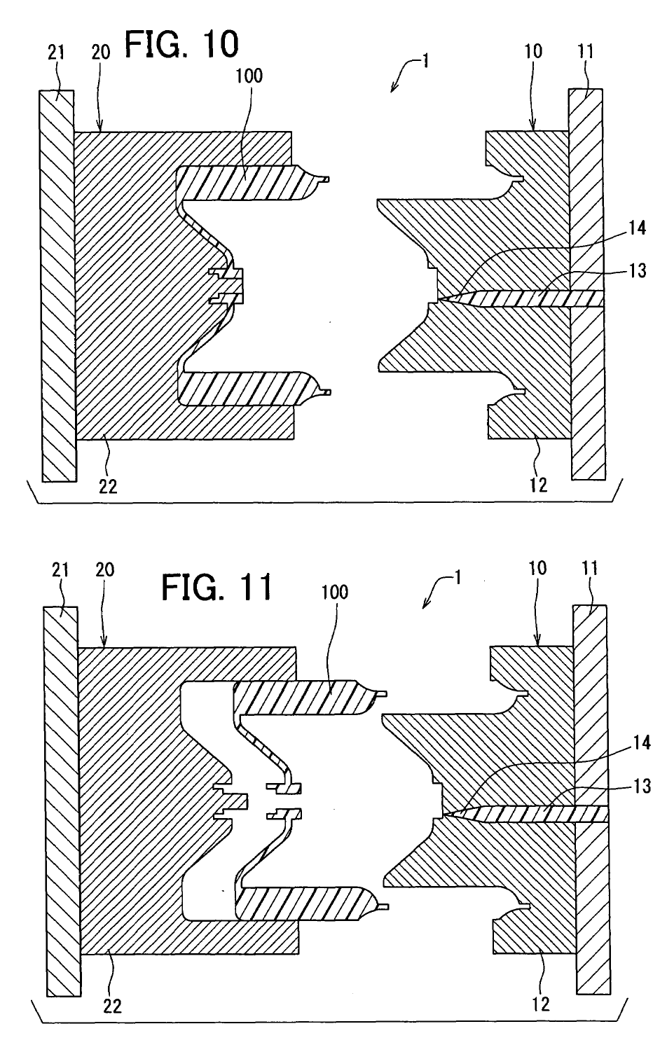

After the resin filled in the product portion 30 is cooled and hardened, i.e., the fan 100 is molded, the fixed mold 10 and the movable mold 20 are opened, as shown in FIG. 10. Then, as shown in FIG. 11, the fan 100 is ejected from the movable mold 20 by the operation of the ejector unit 70. Then, the fan 100 is removed from the fixed mold 10 and the movable mold 20 by using a removing device (not shown).

Thus, the step shown in FIG. 8 is referred to as a mold-closing step for closing the mold unit 1. The step shown in FIG. 9 is referred to as a filling step for injecting the molten resin and filling the product portion 30 with the molten resin as well as a cooling step for cooling and hardening the resin in the product portion 30. Further, the step shown in FIG. 10 is referred to as a mold-opening step for opening the mold unit 1. The step shown in FIG. 11 is referred to as an ejecting step or a removing step for removing the fan 100 from the product portion 30.

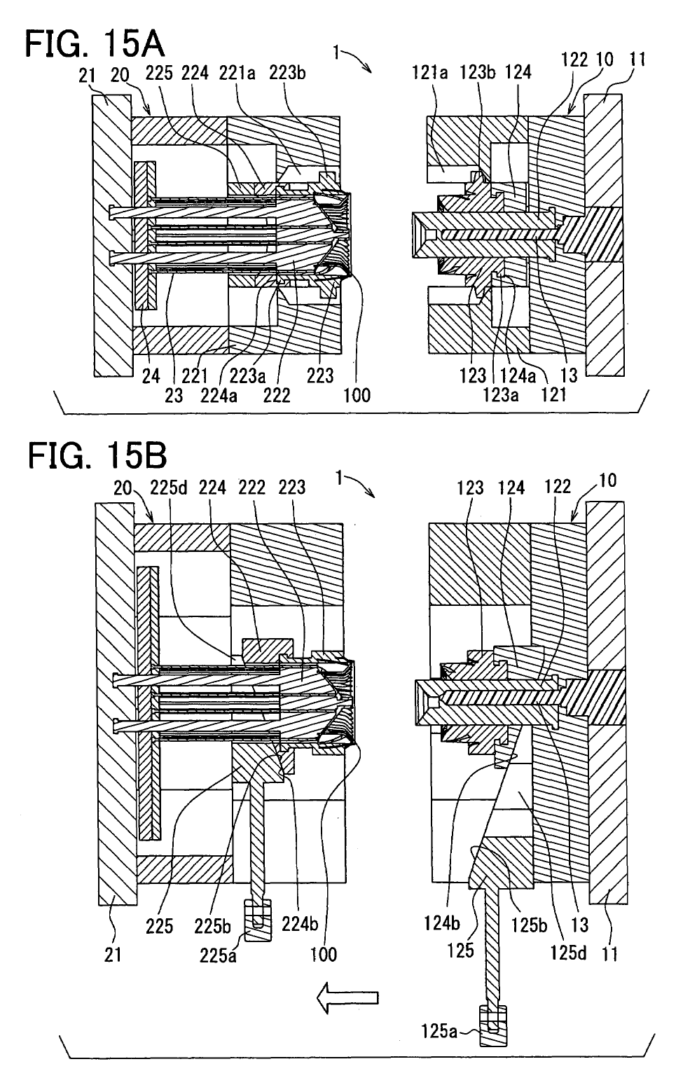

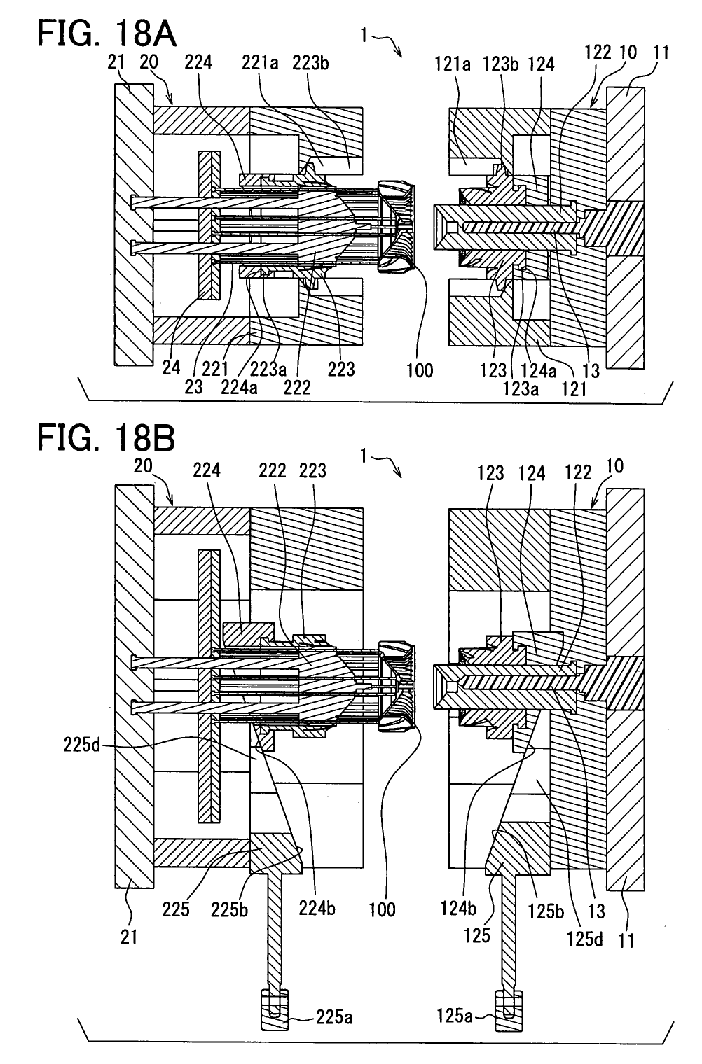

The mold-opening step and the removing step after the cooling step are also referred to as a separation step. The characteristic operation of the mold unit 1 in the separation step will be described hereafter with reference to FIGS. 12A to 19. FIGS. 12A, 13A, 15A, 16A, 18A show cross-sections of the mold unit 1 taken at a position corresponding to a line XIIA-XIIA in FIG. 2. FIGS. 12B, 13B, 15B, 16B, 18B show cross-sections of the mold unit 1 taken at a position corresponding to a line XIIB-XIIB in FIG. 2. Also, FIGS. 12A and 12B are detailed views of the mold unit 1 in a condition shown in FIG. 9. FIGS. 15A and 15B are detailed views of the mold unit 1 in a condition shown in FIG. 10. FIG. 18A and 18B are detailed views of the mold unit 1 in a condition shown in FIG. 11.

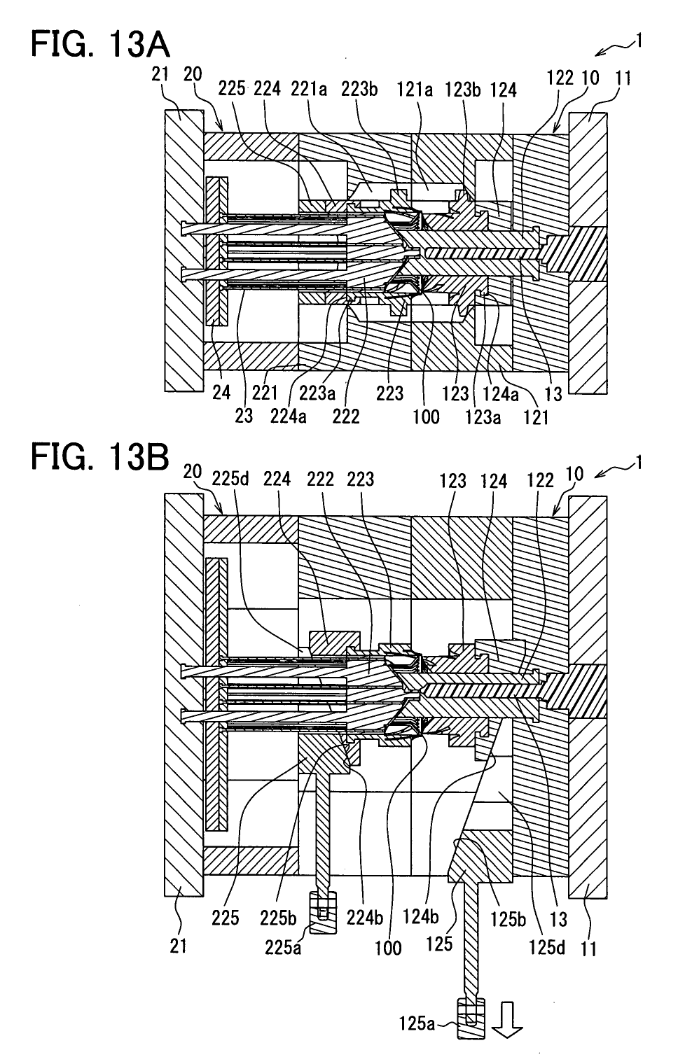

As shown in FIGS. 12A and 12B, the fan 100 is molded in the product portion 30 through the filling step and the cooling step. Thereafter, as shown in FIG. 13B, the wedge plate 125 is slid in the downward direction by the hydraulic cylinder 15.

With this operation, the supporting block 124, which is engaged with the wedge plate 125, is moved in the right direction in FIGS. 13A and 13B. Further, with the movement of the supporting block 124, the blade-molding core member 123 receives the biasing force in the right direction in FIGS. 13A and 13B, i.e., substantially in the mold opening direction of the fixed mold 10.

The blade-molding core member 123 is rotatably supported by the supporting block 124, and the guide piris 123b are guided in the guide grooves 121a when moving in the right direction as shown in FIG. 13A. Therefore, the blade-molding core member 123 spirally moves about the passage-forming member 122.

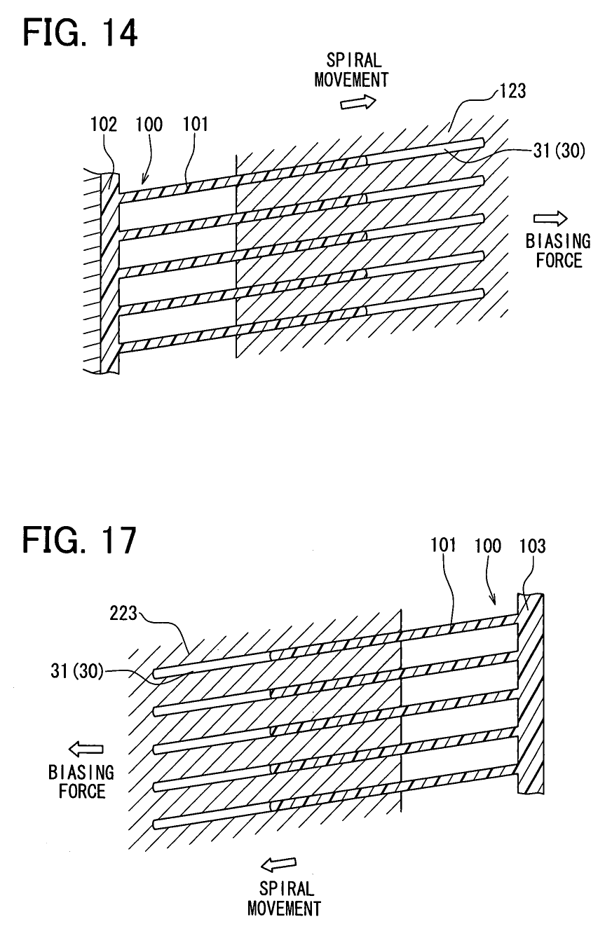

Namely, as shown in FIG. 14, the blade-molding core member 123 spirally moves about the rotation axis 110 along the inclination of the blades 101, which are molded in the blade-molding portion 31 of the product portion 30. In this way, the blade-molding core member 123 is pulled out or separated from the blades 101, which form undercut structure.

After the blade-molding core member 123 is separated from the blades 101, the movable mold 20 is moved away from the fixed mold 10 by the mold opening and closing unit 60. Thus, the mold unit 1 is opened, as shown in FIGS. 15A and 15B.

At this time, because the blades 101 are still partially located within the blade-molding core member 223 of the movable mold 20, a frictional connecting force between the fan 100 and the movable mold 20 is sufficiently larger than a frictional connecting force between the fan 100 and the fixed mold 10. Thus, the mold unit 1 is opened in a condition that the fan 100 is securely held by the movable mold 20.

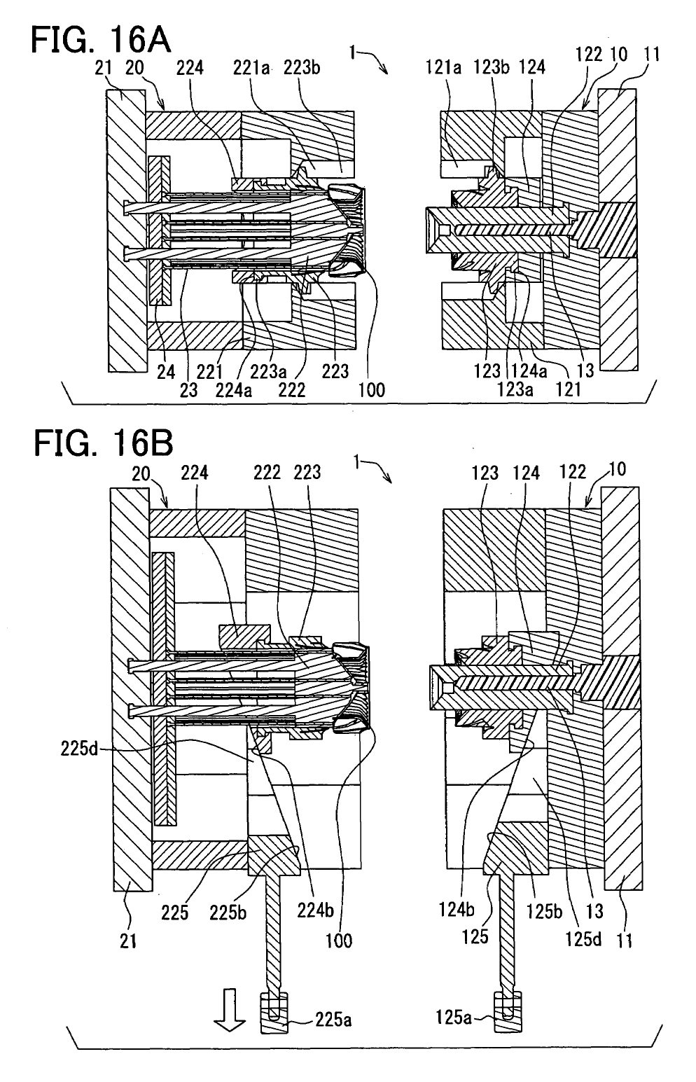

After the mold unit 1 is opened, an operation for separating the blade-molding core member 223 from the blades 101 is performed. As shown in FIG. 16B, the hydraulic cylinder 25 is driven by the control unit 50, and thus the wedge plate 225 is slid in the downward direction.

With this operation, the supporting block 224, which is engaged with the wedge plate 225, is moved in the left direction of FIGS. 16A and 16B. Further, with the movement of the supporting block 224, the blade-molding core member 223, which is engaged with the supporting block 224, receives the biasing force in the left direction, i.e., substantially in the mold opening direction of the movable mold 20.

The blade-molding core member 223 is rotatably supported by the supporting block 224, and the guide pins 223b are guided in the guide grooves 221a when moved in the left direction as shown in FIG. 16A. Therefore, the blade-molding core member 223 spirally moves.

Namely, as shown in FIG. 17, the blade-molding core member 223 spirally moves about the rotation axis 110 along the inclination of the blades 101, which are molded in the blade-molding portion 31 of the product portion 30. In this way, the blade-molding core member 223 is separated from the blades 101, which form undercut structure.

After the blade-molding core member 223 is separated from the blades 101, as shown in FIGS. 18A and 18B, the ejector plate 24 is pushed in the right direction by the operation of the ejector unit 70. With this, the fan 100 is pushed by the ejector pins 23 and ejected from the movable mold 20.

The step shown in FIGS. 13A and 13B corresponds to a spirally moving step in the fixed mold 10. The step shown in FIGS. 15A and 15B corresponds to the mold-opening step. The step shown in FIGS. 16A and 16B corresponds to a spirally moving step in the movable mold 20. The step shown in FIGS. 18A and 18B corresponds to the ejecting step.

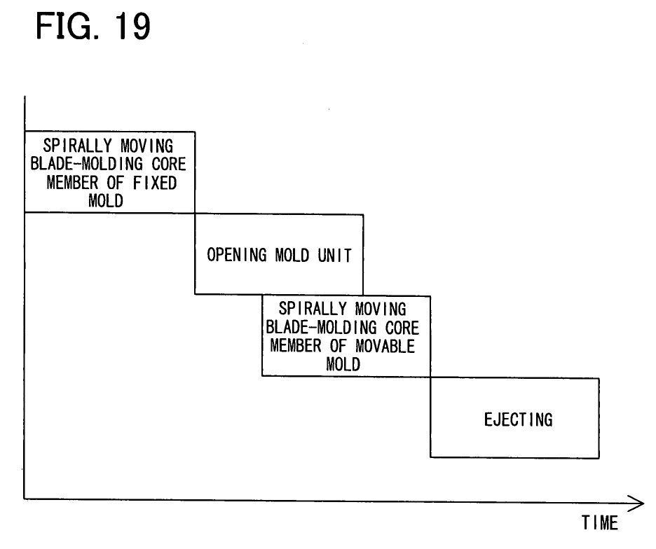

FIG. 19 shows a time chart of the operation of the fan forming apparatus for separating the fan from the mold unit 1. As shown in FIG. 19, the mold opening step is started right after completion of the spirally moving step of the fixed mold 10. After the mold-opening step is started, the spirally moving step of the movable mold 20 is started. Further, right after the completion of the spirally moving step of the movable mold 20, the ejecting step is started.

The mold-opening step is performed at least right after or after the completion of the spirally moving step of the fixed mold 10. The spirally moving step of the movable mold 20 is performed at least after the mold-opening step is started. The ejecting step is performed at least right after or after the completion of the spirally moving step of the movable mold 20.

Specifically, the mold opening is performed at least right after or after the blade-molding core member 123 is separated from the blades 101. Also, the spiral movement of the blade-molding core member 223 of the movable mold 20 is started at least right after or after the fan 100 is separated from the fixed mold 10 by the mold opening. The ejecting of the fan 100 from the movable mold 20 is performed at least right after or after-the blade-molding core member 223 of the movable mold 20 is separated from the blades 101.

Therefore, in a case that the separation of the blade-molding core member 223 of the movable mold 20 from the blades 101 is completed before the completion of the mold opening step, the ejecting step can be started when the blade-molding core member 223 is separated from the blades 101 and a mold opening dimension between the fixed mold 10 and the movable mold 20 is greater than an axial dimension of the fan 100. That is, when the mold opening dimension is greater than the axial dimension of the fan 100, it is considered that a clearance is sufficiently maintained between the fixed mold 10 and the movable mold 20 so that the fan 100 pushed by the ejector pins 23 will not interfere with the fixed mold 10.

In the above structure and operation, when the fan 100 is ejected from the mold unit 1, the blade-molding core members 123, 223 of the fixed and movable molds 10, 20 are already separated from the blades 101. Therefore, the fan 100 is easily ejected from the mold unit 1.

When separating from the blades 101, the blade-molding core members 123, 223 are spirally moved about the rotation axis 110 and along the inclination of the blades 101. Therefore, each of the blade-molding core members 123, 223 is easily separated from the blades 101 at once.

Also, the blade-molding core members 123, 223 are generally moved in the direction parallel to the rotation axis 110 while rotating. In other words, the blade-molding core members 123, 223 are not moved in a radially outward direction, when separating from the blades 101. Therefore, it is less likely that the mold unit 1 will increase in size.

The mold-opening step is performed after the completion of the spirally moving step of the blade-molding core member 123 of the fixed mold 10. Namely, when the mold unit 1 is opened, the blade-molding core member 123 is already separated from the blades 101, which form the undercut structure. Therefore, in opening the mold unit 1 in a condition that the fan 100 is held by the movable mold 20, the blades 101 are easily ejected from the fixed mold 10.

The spirally moving step of the blade-molding core member 223 of the movable mold 20 is started after the mold-opening step is started. Namely, when the mold-opening step is started, the blade-molding core member 223 is still engaged with the blades 101. Therefore, the fan 100 is securely held in the movable mold 20 when the mold unit 1 is opened.

The ejecting step by the ejector pins 23 is performed after the completion of the spirally moving step of the blade-molding core member 223 of the movable mold 20. Namely, when the fan 100 is ejected from the movable mold 20, the blade-molding core member 223 is already separated from the blades 101, which have the undercutting structure. Therefore, the fan 100 is easily ejected.

When receiving the biasing force in the mold opening direction, the blade-molding core members 123, 223 move in the mold opening direction while rotating along the inclination of the blades 101. This spiral movement is easily provided by the guiding part between the guide pins 123b, 223b and the guide grooves 121a, 221a.

The biasing forces applied to the blade-molding core member 123, 223 are caused by the movement of the supporting blocks 124, 224 in the mold opening direction when the wedge plates 125, 225 are moved in the direction parallel to the mold opening direction. Namely, the biasing forces are caused by the mechanism that is moved in the direction perpendicular to the mold opening direction. Therefore, the mechanism for causing the biasing forces will not interfere with the passage for supplying the molten resin and the ejector device. Also, the hydraulic cylinders 15, 25 as the driving devices for causing the biasing forces are easily mounted.

The blade-molding core members 123, 223 are rotatably supported by the supporting blocks 124, 224. Therefore, the blade-molding core members 123, 223 are easily spirally moved by the guiding part provided by the guide pins 123b, 223b and the guide grooves 121a 221a.

### Other Embodiments

In the above embodiment, the driving device for causing the spiral movement of the blade-molding core members 123, 223 are provided by the hydraulic cylinders 15, 25. However, the driving devices are not limited to the hydraulic cylinders 123, 223, but may be provided by another device such as air cylinders and servomotors.

In the above embodiment, the wedge plates 125, 225 as the sliding members are moved in the direction perpendicular to the mold opening direction. However, the biasing forces may be caused by moving the sliding members in other directions such as a direction that intersects the mold opening direction.

For example, if the servomotor is employed as the driving device and is easily installed inside of the mold unit 1, the biasing forces in the mold opening direction can be directly applied to the supporting members 124, 224 without using the wedge sliding members.

In a case that the end of the driving device is configured to have spiral movement, the blade-molding core members 123, 223 can be directly operated to make the spiral movement by the driving device.

In the above embodiment, the fixed mold 10 and the movable mold 20 respectively have the blade-molding core members 123, 223 and both of the blade-molding core members 123, 223 are spirally moved due to the positional relationship between the blades 101 and the disc portion 102 and the positional relationship between the blades 101 and the shroud ring 103. However, the shape of the fan 100 is not limited to the illustration shown in FIGS. 6A, 6B and 7. Depending on the shape of the fan 100, the blade-molding core member for molding the blades may be provided on one of the fixed mold 10 and the movable mold 20 and moved in the spiral manner.

The fan 100, which formed in the mold unit 1, is not limited to the sirocco fan 100, but may be other fans such as a turbofan. Any other centrifugal fans having blades that are inclined in the circumferential direction at predetermined angles relative to the rotation axis may be formed by the mold unit 1 and the fan forming apparatus discussed in the above.

In the above discussion, the mold opening direction is exemplary described in the horizontal direction, i.e., in the right and left direction in the drawings. However, the mold opening direction is not limited to the horizontal direction, but may be a vertical direction or the like. In the above discussion, the upward direction, the downward direction, the left direction and the right direction are used for convenience in explanation.

The example embodiments of the present invention are described above. However, the present invention is not limited to the above embodiments, but may be implemented in other ways without departing from the spirit of the invention.

What is claimed is:

1. A mold unit for molding a centrifugal fan that defines a rotation axis and has a plurality of blades arranged in a circumferential direction about the rotation axis, and each of the plurality of blades extending in a direction that is inclined in the circumferential direction at a predetermined angle relative to a direction parallel to the rotation axis, the mold unit comprising:
a first mold; and
a second mold providing a cavity with the first mold when the first and second molds are disposed in a mold close position, the cavity having a shape corresponding to the centrifugal fan for molding the centrifugal fan therein, and at least one of the first mold and the second mold being movable in a mold opening direction, which is parallel to the rotation axis of the centrifugal fan to be molded in the cavity, to open the cavity, wherein
at least one of the first mold and the second mold has a blade-molding core member and a spiral movement generating structure,
the blade-molding core member defines at least a portion of the cavity for molding the blades of the centrifugal fan, and
the spiral movement generating structure is configured to move the blade-molding core member in a spiral manner along inclination of the blades about the rotation axis.

2. The mold unit according to claim 1, wherein
the spiral movement generating structure includes a biasing force generating part and a guiding part,
the biasing force generating part is configured to generate a biasing force for biasing the blade-molding core member in a direction parallel to the mold opening direction, and
the guiding part is configured to guide the blade-molding core member so that the blade-molding core member moves in the spiral manner.

3. The mold unit according to claim 2, wherein
the biasing force generating part includes a supporting member that supports the blade-molding core member such that the blade-molding core member is rotatable about the rotation axis, and
the biasing force is applied to the blade-molding core member through the supporting member.

4. The mold unit according to claim 3, wherein
the biasing force generating part includes a sliding member having a wedge shape, the sliding member is engaged with the supporting member and is slidable in a direction that intersects the mold opening direction, and
the biasing force is applied to the blade-molding core member with a sliding movement of the sliding member.

5. The mold unit according to claim 4, wherein
the sliding member is included in the first mold,
the first mold has a passage portion defining a passage for supplying a molten resin into the cavity,
the sliding member is formed with a notched portion and is disposed such that the passage portion extends through the notched portion, and
the notched portion has a predetermined shape so that the sliding member is slidable without interfering with the passage portion.

6. The mold unit according to claim 4, wherein
the sliding member is included in the second mold,
the second mold has an ejecting device for ejecting the centrifugal fan from the cavity,
the sliding member is formed with a notched portion and the ejecting device extends through the notched portion, and
the notched portion has a predetermined shape so that the sliding member is slidable without interfering with the ejecting device.

7. The mold unit according to claim 2, wherein
at least one of the first mold and the second mold has a main body,
the blade-molding core member is housed in the main body,
one of the blade-molding core member and the main body is formed with a guide groove and the other one of the blade-molding core member and the main body has a guide projection received in the guide groove,
the guide groove extends along the inclination of the blades, and
the guiding part is provided by the guide groove and the guide projection.

8. A method for forming a centrifugal fan that defines a rotation axis and has a plurality of blades arranged in a circumferential direction about the rotation axis and each of the plurality of blades extending in a direction that is inclined in the circumferential direction at a predetermined angle relative to a direction parallel to the rotation axis, the method comprising:
closing a first mold and a second mold such that a cavity having a shape corresponding to the centrifugal fan is provided between the first mold and the second mold, at least one of the first mold and the second mold having a blade-molding core member that defines at least a portion of the cavity for molding the blades;
injecting a molten resin into the cavity;
opening the first mold and the second mold after the resin is solidified; and
ejecting the centrifugal fan molded in the cavity from the second mold, the method further comprising:
moving the blade-molding core member in a spiral manner along inclination of the blades and about the rotation axis for separating the blade-molding core member from the blades of the centrifugal fan, before the ejecting.

9. The method according to claim 8, wherein
the moving includes generating a biasing force for biasing the blade-molding core member in a direction parallel to a mold opening direction in which at least one of the first mold and the second mold is moved to open the cavity, and guiding the blade-molding core member such that the blade-molding core member moves in the spiral manner.

10. The method according to claim 9, wherein
the generating includes supporting the blade-molding core member by a supporting member such that the blade-molding core member is rotatable about the rotation axis, and applying the biasing force to the blade-molding core member through the supporting member.

11. The method according to claim 10, wherein
the generating includes sliding a sliding member, which is engaged with the supporting member, in a direction that intersects the mold opening direction, and
the applying of the biasing force to the blade-molding core member through the supporting member is performed with the sliding of the sliding member.

12. The method according to claim 8, wherein
the moving includes spirally moving the blade-molding core member of the first mold, and
the opening is performed after completion of the spirally moving of the blade-molding core member of the first mold.

13. The method according to claim 8, wherein
the moving includes spirally moving the blade-molding core member of the second mold, and
the spirally moving of the blade-molding core member of the second mold is performed after the opening of the first and second molds is started.

14. The method according to claim 13, wherein
the ejecting is performed after completion of the spirally moving of the blade-molding core member of the second mold.

15. An apparatus for forming a centrifugal fan that defines a rotation axis and has a plurality of blades arranged in a circumferential direction about the rotation axis and each of the plurality of blades extending in a direction that is inclined in the circumferential direction at a predetermined angle relative to the rotation axis, the apparatus comprising:
a mold unit having a first mold and a second mold providing a cavity therebetween, the cavity having a shape corresponding to the centrifugal fan for molding the centrifugal fan therein, wherein at least one of the first mold and the second mold being movable in a mold opening direction, which is parallel to the rotation axis of the centrifugal fan to be molded in the cavity, to open the mold unit, and at least one of the first mold and the second mold has a blade-molding core member and a spiral movement generating structure, the blade-molding core member defines at least a portion of the cavity for molding the blades of the centrifugal fan, and the spiral movement generating structure is configured to move the blade-molding core member in a spiral manner along inclination of the blades about the rotation axis;
a mold opening and closing unit for opening and closing the mold unit;
an ejecting unit for ejecting the centrifugal fan molded in the cavity from the second mold;
a driving device for driving the spiral movement generating structure; and
a control unit for controlling the mold opening and closing unit, the ejecting unit and the driving device.

16. The apparatus according to claim 15, wherein
the control unit controls the mold opening and closing unit, the driving device and the ejecting unit such that the blade-molding core member is moved in the spiral manner before the centrifugal fan is ejected from the second mold, and the centrifugal fan is ejected from the second mold after the mold unit is opened.

17. The apparatus according to claim 15, wherein
the spiral movement generating structure includes a biasing force generating part and a guiding part,
the biasing force generating part is configured to generate a biasing force for biasing the blade-molding core member in a direction parallel to the mold opening direction,
the guiding part is configured to guide the blade-molding core member such that the blade-molding core member moves in the spiral manner when the blade-molding core member receives the biasing force, and
the driving device is controlled to drive the biasing force generating part such that the biasing force generating part generates the biasing force.

18. The apparatus according to claim 17, wherein
the biasing force generating part includes a supporting member that supports the blade-molding core member rotatably about the rotation axis, and
the biasing force is applied to the blade-molding core member through the supporting member.

19. The apparatus according to claim 18, wherein
the biasing force generating part includes a sliding member that is engaged with the supporting member,
the sliding member is configured to be slidable in a direction that intersects a direction parallel to the mold opening direction, and
the driving device is configured to slide the sliding member so that the biasing force is applied to the blade-molding core member through the supporting member with sliding movement of the sliding member.

20. The apparatus according to claim 15, wherein
the first mold includes the blade-molding core member and the spiral movement generating structure, and
the control unit controls the mold opening and closing unit such that the mold unit is opened after the spiral movement generating structure completes spiral movement of the blade-molding core member of the first mold.

21. The apparatus according to claim 15, wherein
the second mold includes the blade-molding core member and the spiral movement generating structure,
the control unit controls the driving device such that the spiral movement generating structure of the second mold moves the blade-molding core member in the spiral manner after the mold opening and closing unit starts opening of the mold unit.

22. The apparatus according to claim 21, wherein
the control unit controls the ejecting unit such that the centrifugal fan is ejected from the second mold after the spiral movement generating structure of the second mold completes spiral movement of the blade-molding core member of the second mold.
